(19) United States
(12) Patent Application Publication
(10) Pub. No.: US 2005/0076179 A1
(43) Pub. Date: Apr. 7, 2005

(54) Cache optimized logical partitioning a symmetric multi-processor data processing system

(75) Inventor: Joel Howard Schopp, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/677,661

(22) Filed: Oct. 2, 2003

(51) Int. Cl. G06F 12/00

(52) U.S. Cl. 711/119; 711/170

(57) ABSTRACT

A method, apparatus, and computer instructions for assigning processors to partitions in a multi-processor data processing system. Optimal allocation sets are generated for unallocated processors in the multi-processor data processing system for a cache level. Each set includes an allocation of unallocated processors to at least one partition. A determination is made as whether a set in the optimal allocation sets match requirements for a set of partitions selected for the data processing system. In response to a match existing, processors in the set are removed from the unallocated processors, wherein cache usage by the processors is optimized for the cache level.

### BACKGROUND OF THE INVENTION

1. Technical Field

The present invention relates generally to an improved data processing system and in particular to a method and apparatus for managing caches in a data processing system. Still more particularly, the present invention relates to a method, apparatus, and computer instructions for optimizing caching within a logical partitioned data processing system.

2. Description of Related Art

Increasingly large symmetric multi-processor data processing systems, such as IBM eServer P690, available from International Business Machines Corporation, DHP9000 Superdome Enterprise Server, available from Hewlett-Packard Company, and the Sunfire 15K server, available from Sun Microsystems, Inc. are not being used as single large data processing systems. Instead, these types of data processing systems are being partitioned and used as smaller systems. These systems are also referred to as logical partitioned (LPAR) data processing systems. A logical partitioned functionality within a data processing system allows multiple copies of a single operating system or multiple heterogeneous operating systems to be simultaneously run on a single data processing system platform. A partition, within which an operating system image runs, is assigned a non-overlapping subset of the platforms resources. These platform allocatable resources include one or more architecturally distinct processors with their interrupt management area, regions of system memory, and input/output (I/O) adapter bus slots. The partition's resources are represented by the platform's firmware to the operating system image.

Each distinct operation system or image of an operating system running within a platform is protected from each other such that software errors on one logical partition cannot affect the correct operations of any of the other partitions. This protection is provided by allocating a disjointed set of platform resources to be directly managed by each operating system image and by providing mechanisms for insuring that the various images cannot control any resources that have not been allocated to that image. Furthermore, software errors in the control of an operating system's allocated resources are prevented from affecting the resources of any other image. Thus, each image of the operating system or each different operating system directly controls a distinct set of allocatable resources within the platform.

With respect to hardware resources in a logical partitioned data processing system, these resources are disjointly shared among various partitions. These resources may include, for example, input/output (I/O) adapters, memory DIMMs, non-volatile random access memory (NVRAM), and hard disk drives. Each partition within an LPAR data processing system may be booted and shut down over and over without having to power-cycle the entire data processing system. The number of processors in a partition is based on customer needs, not on the relation of processors to caches. The present invention recognizes that the manner in which assignment of processors to these disparate partitions may have a dramatic affect on performance depending on the assignment of processors with respect to the location of these processors and caches used by the processors.

Therefore, it would be advantageous to have an improved method, apparatus, and computer instructions for optimizing caching in a logical partitioned data processing system with respect to the selection of processors for particular partitions.

### SUMMARY OF THE INVENTION

The present invention provides a method, apparatus, and computer instructions for assigning processors to partitions in a multi-processor data processing system. Optimal allocation sets are generated for unallocated processors in the multi-processor data processing system for a cache level. Each set includes an allocation of unallocated processors to at least one partition. A determination is made as whether a set in the optimal allocation sets match requirements for a set of partitions selected for the data processing system. In response to a match existing, processors in the set are removed from the unallocated processors, wherein cache usage by the processors is optimized for the cache level.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram of a data processing system in which the present invention may be implemented;

FIG. 2 is a block diagram of an exemplary logical partitioned platform in which the present invention may be implemented;

FIG. 3A is a diagram of poorly allocated processors;

FIG. 3B is an example of an optimal processor allocation in accordance with a preferred embodiment of the present invention;

FIG. 4 is a flowchart of a process for allocating processors in a logically partitioned data processing system in accordance with a preferred embodiment of the present invention; and

FIG. 5 is a flowchart of a process for performing passes in accordance with a preferred embodiment of the present invention.

### DETAILED DESCRIPTION OF THE PREFERRED EMBODIMENT

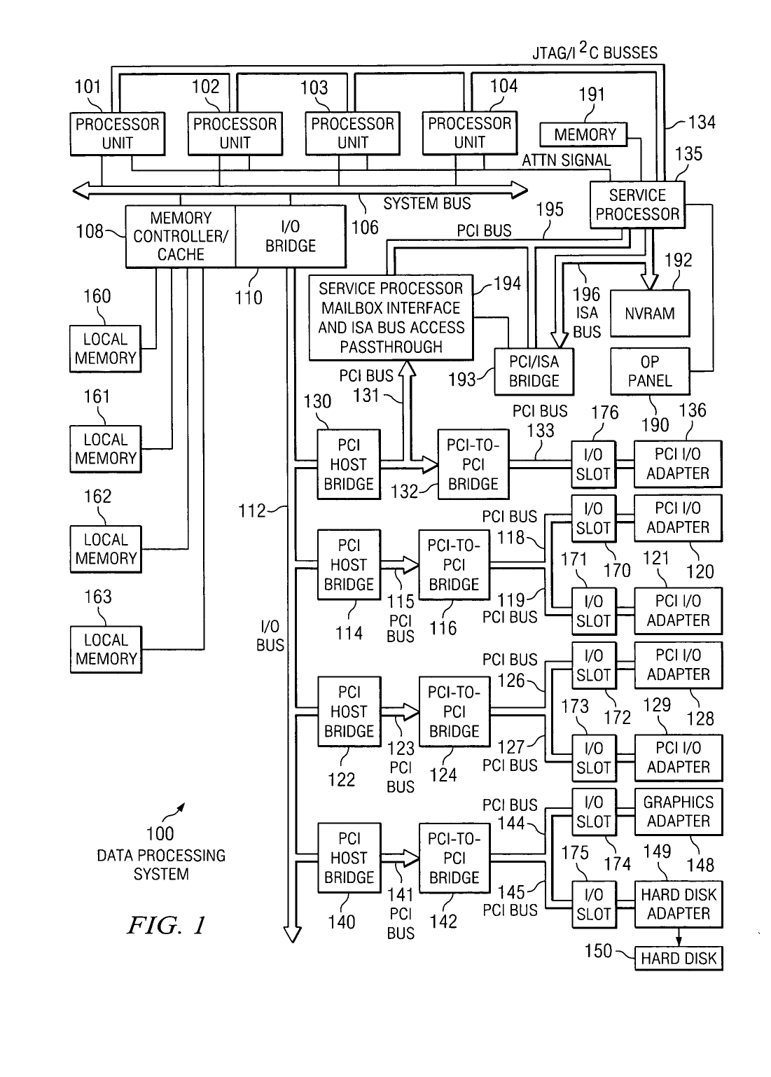

With reference now to the figures, and in particular with reference to FIG. 1, a block diagram of a data processing system in which the present invention may be implemented is depicted. Data processing system 100 is an example of a data processing system with processors that may be allocated using the present invention to optimize cache usage. Data processing system 100 may be a symmetric multi-processor (SMP) system including a plurality of processor units 101, 102, 103, and 104 connected to system bus 106. For example, data processing system 100 may be an IBM eServer, a product of International Business Machines Corporation in Armonk, New York, implemented as a server within a network.

Also connected to system bus 106 is memory controller/cache 108, which provides an interface to a plurality of local memories 160-163. I/O bus bridge 110 is connected to system bus 106 and provides an interface to I/O bus 112. Memory controller/cache 108 and I/O bus bridge 110 may be integrated as depicted.

Data processing system 100 is a logical partitioned (LPAR) data processing system. Thus, data processing system 100 may have multiple heterogeneous operating systems (or multiple instances of a single operating system) running simultaneously. Each of these multiple operating systems may have any number of software programs executing within it. Data processing system 100 is logically partitioned such that different PCI I/O adapters 120-121, 128-129, and 136, graphics adapter 148, and hard disk adapter 149 may be assigned to different logical partitions. In this case, graphics adapter 148 provides a connection for a display device (not shown), while hard disk adapter 149 provides a connection to control hard disk 150.

Thus, for example, suppose data processing system 100 is divided into three logical partitions, P1, P2, and P3. Each of PCI I/O adapters 120-121, 128-129, 136, graphics adapter 148, hard disk adapter 149, each of processor units 101-104, and memory from local memories 160-163 is assigned to each of the three partitions. In these examples, memories 160-163 may take the form of dual in-line memory modules (DIMMs). DIMMs are not normally assigned on a per DIMM basis to partitions. Instead, a partition will get a portion of the overall memory seen by the platform. For example, processor 101, some portion of memory from local memories 160-163, and I/O adapters 120, 128, and 129 may be assigned to logical partition P1; processors 102-103, some portion of memory from local memories 160-163, and PCI I/O adapters 121 and 136 may be assigned to partition P2; and processor 104, some portion of memory from local memories 160-163, graphics adapter 148 and hard disk adapter 149 may be assigned to logical partition P3.

Each operating system executing within data processing system 100 is assigned to a different logical partition. Thus, each operating system executing within data processing system 100 may access only those I/O units that are within its logical partition. Thus, for example, one instance of the Advanced Interactive Executive (AIX) operating system may be executing within partition P1, a second instance (image) of the AIX operating system may be executing within partition P2, and a Windows XP operating system may be operating within logical partition P3. Windows XP is a product and trademark of Microsoft Corporation of Redmond, Wash.

Peripheral component interconnect (PCI) host bridge 114 connected to I/O bus 112 provides an interface to PCI local bus 115. A number of PCI input/output adapters 120-121 may be connected to PCI bus 115 through PCI-to-PCI bridge 116, PCI bus 118, PCI bus 119, I/O slot 170, and I/O slot 171. PCI-to-PCI bridge 116 provides an interface to PCI bus 118 and PCI bus 119. PCI I/O adapters 120 and 121 are placed into I/O slots 170 and 171, respectively. Typical PCI bus implementations will support between four and eight I/O adapters (i.e. expansion slots for add-in connectors). Each PCI I/O adapter 120-121 provides an interface between data processing system 100 and input/output devices such as, for example, other network computers, which are clients to data processing system 100.

An additional PCI host bridge 122 provides an interface for an additional PCI bus 123. PCI bus 123 is connected to a plurality of PCI I/O adapters 128-129. PCI I/O adapters 128-129 may be connected to PCI bus 123 through PCI-to-PCI bridge 124, PCI bus 126, PCI bus 127, I/O slot 172, and I/O slot 173. PCI-to-PCI bridge 124 provides an interface to PCI bus 126 and PCI bus 127. PCI I/O adapters 128 and 129 are placed into I/O slots 172 and 173, respectively. In this manner, additional I/O devices, such as, for example, modems or network adapters may be supported through each of PCI I/O adapters 128-129. In this manner, data processing system 100 allows connections to multiple network computers.

A memory mapped graphics adapter 148 inserted into I/O slot 174 may be connected to I/O bus 112 through PCI bus 144, PCI-to-PCI bridge 142, PCI bus 141 and PCI host bridge 140. Hard disk adapter 149 may be placed into I/O slot 175, which is connected to PCI bus 145. In turn, this bus is connected to PCI-to-PCI bridge 142, which is connected to PCI host bridge 140 by PCI bus 141.

A PCI host bridge 130 provides an interface for a PCI bus 131 to connect to I/O bus 112. PCI I/O adapter 136 is connected to I/O slot 176, which is connected to PCI-to-PCI bridge 132 by PCI bus 133. PCI-to-PCI bridge 132 is connected to PCI bus 131. This PCI bus also connects PCI host bridge 130 to the service processor mailbox interface and ISA bus access pass-through logic 194 and PCI-to-PCI bridge 132. Service processor mailbox interface and ISA bus access pass-through logic 194 forwards PCI accesses destined to the PCI/ISA bridge 193. NVRAM storage 192 is connected to the ISA bus 196. Service processor 135 is coupled to service processor mailbox interface and ISA bus access pass-through logic 194 through its local PCI bus 195. Service processor 135 is also connected to processors 101-104 via a plurality of JTAG/I²C busses 134. JTAG/I²C busses 134 are a combination of JTAG/scan busses (see IEEE 1149.1) and Phillips I²C busses. However, alternatively, JTAG/I²C busses 134 may be replaced by only Phillips I²C busses or only JTAG/scan busses. All SP-ATTN signals of the host processors 101, 102, 103, and 104 are connected together to an interrupt input signal of the service processor. Service processor 135 has its own local memory 191, and has access to the hardware OP-panel 190.

When data processing system 100 is initially powered up, service processor 135 uses the JTAG/I²C busses 134 to interrogate the system (host) processors 101-104, memory controller/cache 108, and I/O bridge 110. At completion of this step, service processor 135 has an inventory and topology understanding of data processing system 100. Service processor 135 also executes Built-In-Self-Tests (BISTs), Basic Assurance Tests (BATs), and memory tests on all elements found by interrogating the host processors 101-104, memory controller/cache 108, and I/O bridge 110. Any error information for failures detected during the BISTs, BATs, and memory tests are gathered and reported by service processor 135.

If a meaningful/valid configuration of system resources is still possible after taking out the elements found to be faulty during the BISTs, BATs, and memory tests, then data processing system 100 is allowed to proceed to load executable code into local (host) memories 160-163. Service processor 135 then releases processor units 101-104 for execution of the code loaded into local memory 160-163. While processor units 101-104 are executing code from respective operating systems within data processing system 100, service processor 135 enters a mode of monitoring and reporting errors. The type of items monitored by service processor 135 include, for example, the cooling fan speed and operation, thermal sensors, power supply regulators, and recoverable and non-recoverable errors reported by processor units 101-104, local memories 160-163, and I/O bridge 110.

Service processor 135 is responsible for saving and reporting error information related to all the monitored items in data processing system 100. Service processor 135 also takes action based on the type of errors and defined thresholds. For example, service processor 135 may take note of excessive recoverable errors on a processor's cache memory and decide that this is predictive of a hard failure. Based on this determination, service processor 135 may mark that resource for deconfiguration during the current running session and future Initial Program Loads (IPLs). IPLs are also sometimes referred to as a “boot” or “bootstrap”.

Data processing system 100 may be implemented using various commercially available computer systems. For example, data processing system 100 may be implemented using IBM eServer iSeries Model 840 system available from International Business Machines Corporation. Such a system may support logical partitioning using an OS/400 operating system, which is also available from International Business Machines Corporation.

Those of ordinary skill in the art will appreciate that the hardware depicted in FIG. 1 may vary. For example, other peripheral devices, such as optical disk drives and the like, also may be used in addition to or in place of the hardware depicted. The depicted example is not meant to imply architectural limitations with respect to the present invention.

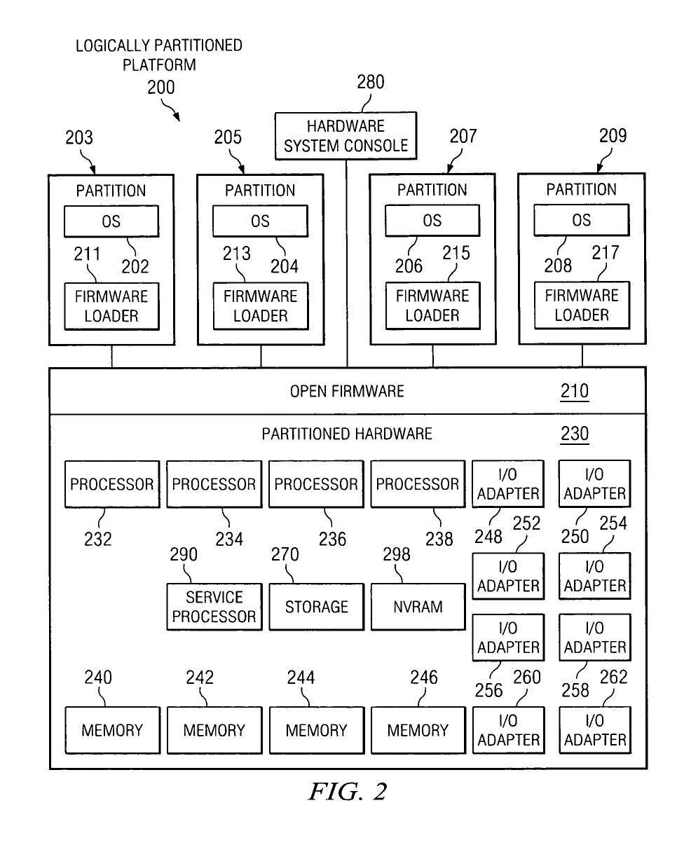

With reference now to FIG. 2, a block diagram of an exemplary logical partitioned platform is depicted in which the present invention may be implemented. The hardware in logical partitioned platform 200 may be implemented as, for example, data processing system 100 in FIG. 1. Logical partitioned platform 200 includes partitioned hardware 230, operating systems 202, 204, 206, 208, and hypervisor 210. Operating systems 202, 204, 206, and 208 may be multiple copies of a single operating system or multiple heterogeneous operating systems simultaneously run on platform 200. These operating systems may be implemented using OS/400, which are designed to interface with a hypervisor. Operating systems 202, 204, 206, and 208 are located in partitions 203, 205, 207, and 209.

Additionally, these partitions also include firmware loaders 211, 213, 215, and 217. Firmware loaders 211, 213, 215, and 217 may be implemented using IEEE-1275 Standard Open Firmware and runtime abstraction software (RTAS), which is available from International Business Machines Corporation. When partitions 203, 205, 207, and 209 are instantiated, a copy of the open firmware is loaded into each partition by the hypervisor's partition manager. The processors associated or assigned to the partitions are then dispatched to the partition's memory to execute the partition firmware.

Partitioned hardware 230 includes a plurality of processors 232-238, a plurality of system memory units 240-246, a plurality of input/output (I/O) adapters 248-262, and a storage unit 270. Partitioned hardware 230 also includes service processor 290, which may be used to provide various services, such as processing of errors in the partitions. Each of the processors 232-238, memory units 240-246, NVRAM storage 298, and I/O adapters 248-262 may be assigned to one of multiple partitions within logical partitioned platform 200, each of which corresponds to one of operating systems 202, 204, 206, and 208.

Partition management firmware (hypervisor) 210 performs a number of functions and services for partitions 203, 205, 207, and 209 to create and enforce the partitioning of logical partitioned platform 200. Hypervisor 210 is a firmware implemented virtual machine identical to the underlying hardware. Hypervisor software is available from International Business Machines Corporation. Firmware is “software” stored in a memory chip that holds its content without electrical power, such as, for example, read-only memory (ROM), programmable ROM (PROM), erasable programmable ROM (EPROM), electrically erasable programmable ROM (EEPROM), and nonvolatile random access memory (nonvolatile RAM). Thus, hypervisor 210 allows the simultaneous execution of independent OS images 202, 204, 206, and 208 by virtualizing all the hardware resources of logical partitioned platform 200.

Operations of the different partitions may be controlled through a hardware management console, such as console 264. Console 264 is a separate data processing system from which a system administrator may perform various functions including reallocation of resources to different partitions.

The manner in which resources in logical partitioned platform 200 are allocated affects the cache usage. In particular, the manner in which processors are allocated can affect the performance of the system. Poor allocations of processors to partitions may result in inefficient use of caches in logical partitioned platform 200. More copies of data may be retained that needed if the processor allocations are made more efficiently.

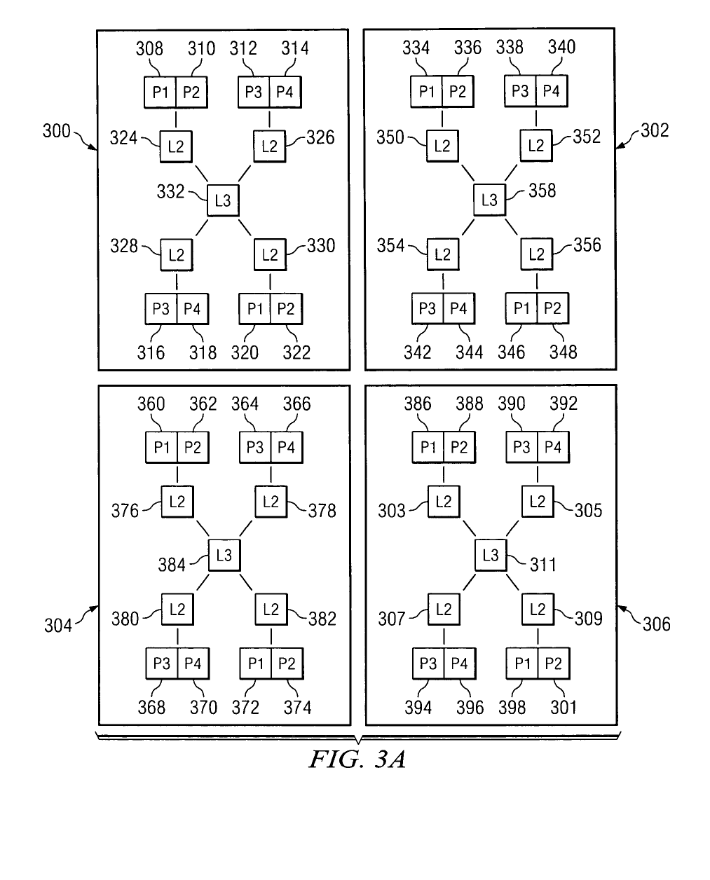

Turning next to FIG. 3A, a diagram of poorly allocated processors is depicted. This example is presented to illustrate the problems that occur with poor allocations of processors to partitions. In this example, a 32 processor system is illustrated containing multi-chip modules 300, 302, 304, and 306. Multi-chip module 300 contains processors 308, 310, 312, 314, 316, 318, 320, and 322. Processor 308 is allocated to partition P1, processor 310 is allocated to partition P2, processor 312 is allocated to partition P3, processor 314 is allocated to partition P4, processor 316 is allocated to partition P3, processor 318 is allocated to partition P4, processor 320 is allocated to partition P1, and processor 322 is allocated to partition P2. This multi-chip module also includes L2 caches 324, 326, 328, and 330. L3 cache 332 also is present in multi-chip module 300.

Next, multi-chip module 302 contains processors 334, 336, 338, 340, 342, 344, 346, and 348. Processor 334 is allocated to partition P1, processor 336 is allocated to partition P2, processor 338 is allocated to partition P3, processor 340 is allocated to partition P4, processor 342 is allocated to partition P3, processor 344 is allocated to partition P4, processor 346 is allocated to partition P1, and processor 348 is allocated to partition P2. Multi-chip module 302 also includes L2 caches 350, 352, 354, and 356. L3 cache 358 also is present in multi-chip module 302.

Next in multi-chip module 304, processors 360, 362, 364, 366, 368, 370, 372, and 374 are present. Processor 360 is allocated to partition P1, processor 362 is allocated to partition P2, processor 364 is allocated to partition P3, processor 366 is allocated to partition P4, processor 368 is allocated to partition P3, processor 370 is allocated to partition P4, processor 372 is allocated to partition P1, and processor 374 is allocated to partition P2. L2 caches 376, 378, 380, and 382 are present in multi-chip module 304 as well as L3 cache 384.

In multi-chip module 306, processors 386, 388, 390, 392, 394, 396, 398, and 301 are present. Processor 386 is allocated to partition P1, processor 388 is allocated to partition P2, processor 390 is allocated to partition P3, processor 392 is allocated to partition P4, processor 394 is allocated to partition P3, processor 396 is allocated to partition P4, processor 398 is allocated to partition P1, and processor 301 is allocated to partition P2. L2 caches 303, 305, 307, and 309 are present along with L3 cache 311 in multi-chip module 306.

As can be seen, the allocation of processors to partitions is made poorly in this example because each processor at a particular partition does not share an L2 cache with any other processor in the same partition. Further, the L3 cache in each module is shared only with one other processor in the same partition. These multi-chip modules are examples of processing units, such as processing units 101, 102, 103, and 104 in FIG. 1.

When accessing data, the worse case scenario is that 8 copies of data are stored in the L2 caches and 4 copies of data are stored in the L3 caches. In this example, in the optimal case, partition 1 is in the first eight processors, Partition 2 contains the second 8 processors, and so on. This type of allocation puts the same data in only 4 of the L2 caches and 1 of the L3 caches. For the worse case scenario, the size of the L2 cache doubles and the size of the L3 cache is tripled.

Current known solutions are to set up partitions along physical boundaries, ignore the problem and suffer performance penalties, or use brute force and try each combination. With 16 partitions and 32 processors, 20.9 trillion combinations are possible.

The present invention provides a method, apparatus, and computer instructions to place partitions optimally with respect to allocating processors. Additionally, the mechanism may place a subset of partitions optimally if the process is not run to completion. This minimizes the affect of placing the remaining partitions in a sub-optimal manner. The mechanism of the present invention does not search through partitions that are to be allocated and match them to the hardware. Instead, the mechanism of the present invention searches by generating optimal partitions for the hardware and seeing if those types of partitions are present. This mechanism may be implemented in an HSC, such as hardware system console 280 in FIG. 2.

This mechanism searches using a method that takes advantage of the fact that higher levels of cache are, by definition, lower multiples of lower levels of cache. As a result, searches may progress down cache levels. The mechanism of the present invention starts by searching larger cache levels, removing larger partitions first. As optimal placements are found for processors, the processors and partitions are removed from consideration. In the illustrative examples, each level of search has multiple passes. The number of passes for each level is determined by the fan-out factor between the number of processors and current search level and the previous search level. With respect to the example illustrated in FIG. 3A, 4 passes are performed at the L3 level because 32 processors are present at the higher level and 8 processors are present at the current level.

Further, for each pass, all sets of partitions are generated in which the number of CPUs in each partition is a multiple of the number of processors at the current level and where the number of processors in all of the partitions add up to the number of processors at the previous level. If a match is found, those processors are removed from the unallocated machine and the partitions are removed from the unallocated partitions. In the illustrative example, the generated sets would be as follows: pass 1: {32}; pass 2: {24,8}{16,16}; pass 3: {16,8,8}; and pass 4: {8,8,8,8}. Pass 1 generates a case in which 32 processors are assigned to a single partition. Pass 2 generates two sets in which optimal allocations of processors are presented for two partitions. Pass 3 shows an optimal allocation of processors for three partitions. Pass 4 generates a processor allocation for 4 partitions. These are examples of optimal sets for different numbers of partitions.

The sets refer to generic processor resources. At the time these sets are generated, the sets do not refer to specific processor allocations. Instead, the sets refer to generic optimal processor sets. It may be possible to find multiple specific processor allocations that would match the generic optimal processor set. For examples in FIG. 3, if no processors had been allocated and a set such as {8,8,8,8} is generated, 4 optimal sets of processors are present that that could be used for any of the 8s. The processors in processor units 300, 302, 304, and 306, respectively, are examples. For the sake of simplicity, it is easiest to arrange the processors in an affinity order of some kind. This order is usually the order the processors are represented by the system, such as 1, 2, 3, 4, and 5.

If the processors are not already in the proper order, the processors may be arranged in a tree type structure. Then, a fairly straightforward leftmost tree traversal may be used will arrange the selection of processors. Once the processors are in order, then the processors may be allocated using the order.

In these examples, the number of passes for the highest level is 0 because a higher level for use in making comparisons is absent. As a result, passes on the highest level are not possible. The number of passes may be further reduced by using the minimum of either the number given in the example or the number of partitions that are multiples of the number of processors at the level. This rule prevents searching through many passes that may not possibly have a match. Further, redundant sets are not generated. For example, {1,3,1} and {1,1,3} are considered the same set and only one of these sets are generated.

Further, if no matching sets are generated, whose total processor usage adds up to the highest level, the search is repeated on the level below. If the search is on an L3 cache level, the search then moves to a level below, the L2 cache level. If more than one previous level is present, it is necessary to generate sets that fall nicely across the previous levels, first, successfully moving restrictions on levels falling optimally across lower levels.

Turning next to FIG. 3B, an example of an optimal processor allocation is depicted in accordance with a preferred embodiment of the present invention. In this example, the 32 processor system in FIG. 3A is illustrated containing multi-chip modules 300, 302, 304, and 306 having an optimal allocation of processors to optimize cache usage. As can be seen all of the processors in multi-chip module 300 are allocated to partition P1, the processors in multi-chip module 302 are allocated to partition P2, the processors in multi-chip module 304 are allocated to partition P3, and the processors in multi-chip module 308 are allocated to partition P4.

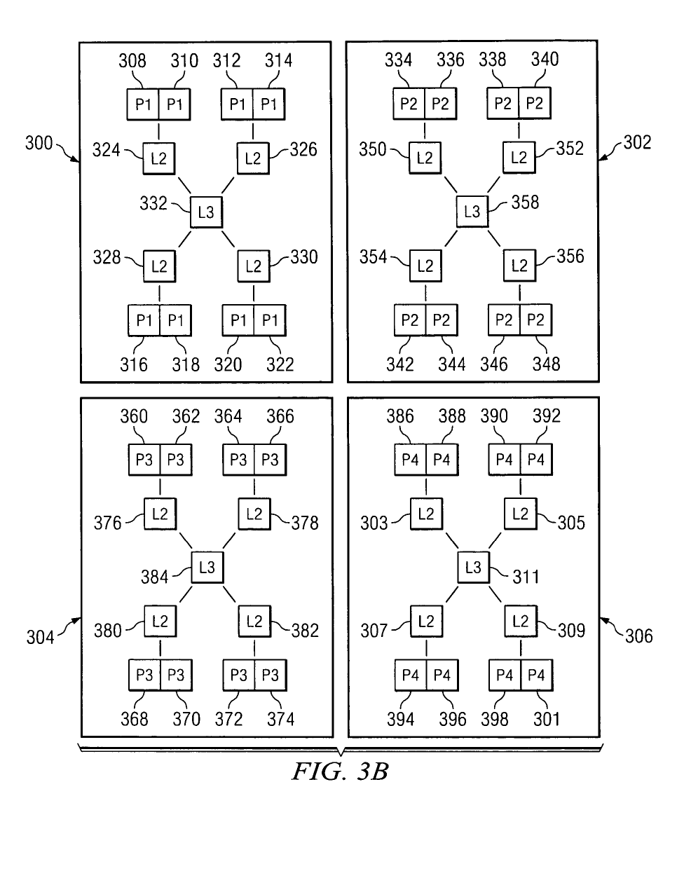

Turning now to FIG. 4, a flowchart of a process for allocating processors in a logically partitioned data processing system is depicted in accordance with a preferred embodiment of the present invention. The process illustrated in FIG. 4 may be implemented in a hardware management console, such as hardware management console 208 in FIG. 2.

The process begins by setting the variable level equal to the highest cache level and the variable n equal to the total number of processors (step 400). For example, the highest cache level in the illustrative example in FIG. 3 is 3. The total number of processors in that example is 32.

Passes are then performed (step 402). A determination is made as to whether any of the passes result in a match (step 404). If a match occurs, the matched processors are subtracted from n (step 406). These matched processors are no longer unallocated processors and are not considered in future passes. Partitions with matches are removed from the unallocated partitions (step 408).

Thereafter, a determination is made as to whether n is less than or equal to 1 (step 410). This step is used to determine whether the process has completed. If n is not less than or equal to 1, the process returns to step 402 as described above. Otherwise, the process terminates.

With reference again to step 404, if a match does not occur in step 402, the level is set equal to level minus 1 (step 412). In other words, the levels decremented to search on the next lower level. A determination is made as to whether the number of processors in level is greater than 1 (step 414). If the number of processors in level is greater than 1, the process returns to step 402. Otherwise, the process terminates.

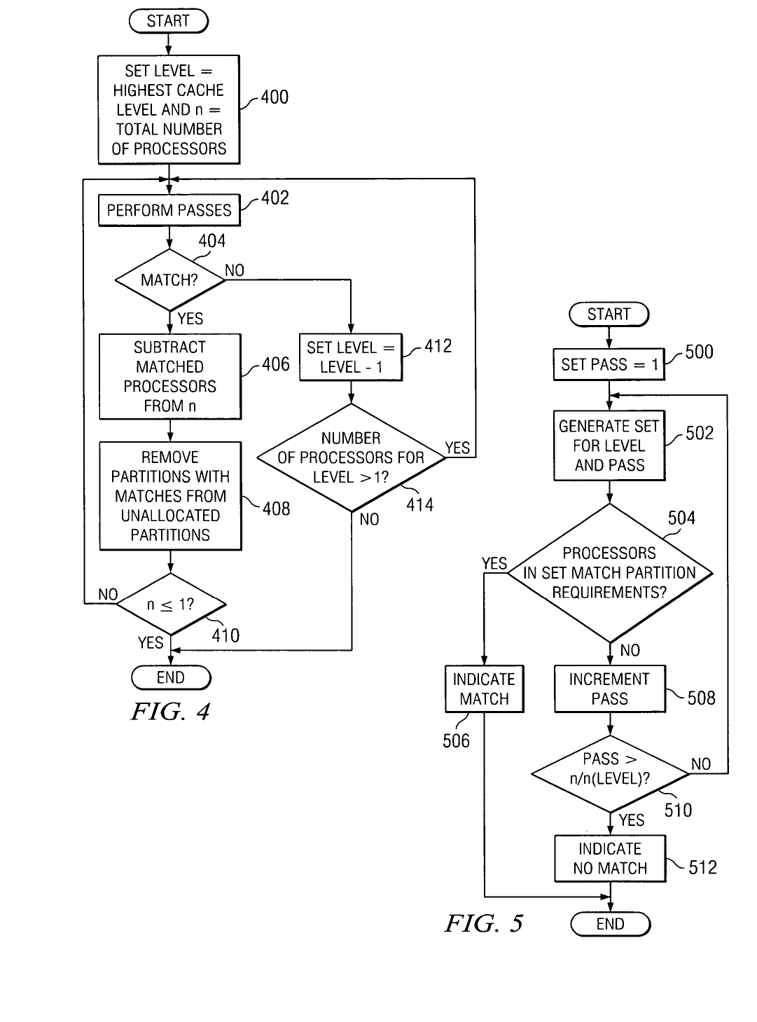

Turning next to FIG. 5, a flowchart of a process for performing passes is depicted in accordance with a preferred embodiment of the present invention. The process illustrated in FIG. 5 is a more detailed description of step 402 in FIG. 4.

The process begins by setting the variable pass equal to 1 (step 500). A set is generated for the level and pass (step 502). Step 502 is equivalent to make a pass through a level. The pass has a value that is equal to the number of partitions that need processors. The number of passes made is up to the number of processors divided by the level. If four partitions are present the pass number used to allocated processors to the partition is 4. In generating sets for a pass, a number of members equal to the pass number is generated. In other words, the number of each member in the set is a multiple of the number of processors in the level and is less than or equal to [n-n(level)(pass-1)], where n is the number of processors and n(level) is the number of processors in a level. Valid set numbers are added to n.

Each member in the set can only be as large as the number of available processors n. Each member in a set can only be as small as the number of processors in a level n(level). Because the total of all members must be less than or equal to n, the number of available processors. When more than one member is present, it follows that no individual member can be as large as n, because then other members would have to be 0. More than one member is present when the pass is greater than 1. The above equation shows that for a member in a set the maximum possible value is n—the minimum values for the other members in the set. Knowing this may be useful when generating sets, depending on how the set generation is performed. This illustrates that as the passes increase the range of possible values for set members decreases, which slightly offsets the additional work of generating larger sets.

A determination is then made as to whether the processors in the set match partition requirements (step 504). If processors are assigned to a partition, that partition is no longer considered in allocating processors. Thus, if four partitions need allocations, and an allocation is made to one of the four partitions, then, the pass number is set to a value of 3 instead of 4. If the processors in the set match the partition requirements, a match is indicated (step 506) with the process terminating thereafter.

With reference again to step 504, if the processors in the set do not match the partition requirements, the variable pass is incremented (step 508). A determination is then made as to whether the variable pass is greater than the number of processors divided by the number of processors in the levels (step 510). If the variable pass is not greater than the number of processors divided by the number of processors in the level, the process returns to step 502 as described above. Otherwise, an indication that no match is present is made (step 512) with the process terminating thereafter.

Thus, the present invention provides an improved method, apparatus, and computer instructions for allocating processors to partitions. The mechanism of the present invention allocates processors by generating optimal partitions for the hardware and checking to see whether those partitions are present. In other words, optimal processor allocations for different partitions are made to generate a set and the set is checked to see whether the partition has requirements for those types of processor allocations. Further, the mechanism of the present invention starts a search with the larger cache levels, such as an L3 cache rather than an L2 cache. In this manner, problems associated with poor cache usage in poorly allocated systems may be avoided or reduced.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method for assigning processors to partitions in a multi-processor data processing system, the method comprising:
generating optimal allocation sets for unallocated processors in the multi-processor data processing system for a cache level, wherein each set includes an allocation of unallocated processors to at least one partition;
determining whether a set in the optimal allocation sets match requirements for a set of partitions selected for the data processing system; and
responsive to a match existing, removing processors in the set from the unallocated processors, wherein cache usage by the processors is optimized for the cache level.

2. The method of claim 1 further comprising:
repeating the generating step, the determining step, and the removing step is performed for each cache level.

3. The method of claim 2, wherein the method starts at a highest cache level and moves to successively lower cache levels until all cache levels have been processed.

4. The method of claim 1 further comprising:
removing a partition from the set of partitions in response to allocating a set to the partition.

5. The method of claim 1, wherein the multi-processor data processing system is a symmetric multi-processor data processing system.

6. The method of claim 1, wherein the multi-processor data processing system includes an L3 cache and an L2 cache.

7. The method of claim 1, wherein the processors are located on multi-chip modules in which optimal allocations of the processors to partitions to optimize cache usage depends on a location of the processors on the multi-chip modules.

8. A method for allocating processors to optimize cache usage in a multi-processor data processing system, the method comprising:
selecting a highest cache level that has been unprocessed in the multi-processor data processing system;
generating a set of processor allocations having a desired level of cache optimization, wherein the set includes unallocated processors;
responsive to the generating step, determining whether the set matches a requirement for partitions within the set of partitions;
responsive to a match, allocating processors in the set to the partitions to form allocated processors; and
responsive to an absence of the match, repeating the generating set to generate a different set of processor allocations.

9. A data processing system for assigning processors to partitions in a multi-processor data processing system, the data processing system comprising:
a bus system;
a communications unit connected to the bus system;
a memory connected to the bus system, wherein the memory includes a set of instructions; and
a processing unit connected to the bus system, wherein the processing unit executes the set of instructions to generate optimal allocation sets for unallocated processors in the multi-processor data processing system for a cache level, in which each set includes an allocation of unallocated processors to at least one partition; determine whether a set in the optimal allocation sets match requirements for a set of partitions selected for the data processing system; responsive to a match existing, remove processors in the set from the unallocated processors, in which cache usage by the processors is optimized for the cache level.

10. A data processing system for assigning processors to partitions in a multi-processor data processing system, the data processing system comprising:
generating means for generating optimal allocation sets for unallocated processors in the multi-processor data processing system for a cache level, wherein each set includes an allocation of unallocated processors to at least one partition;
determining means for determining whether a set in the optimal allocation sets match requirements for a set of partitions selected for the data processing system; and
removing means, responsive to a match existing, for removing processors in the set from the unallocated processors, wherein cache usage by the processors is optimized for the cache level.

11. The data processing system of claim 10 further comprising:
repeating the generating means, the determining means, and the removing means is performed for each cache level.

12. The data processing system of claim 11, wherein the method starts at a highest cache level and moves to successively lower cache levels until all cache levels have been processed.

13. The data processing system of claim 10, wherein the removing means is a first removing means further comprising:
second removing means for a partition from the set of partitions in response to allocating a set to the partition.

14. The data processing system of claim 10, wherein the multi-processor data processing system is a symmetric multi-processor data processing system.

15. The data processing system of claim 10, wherein the multi-processor data processing system includes an L3 cache and an L2 cache.

16. The data processing system of claim 10, wherein the processors are located on multi-chip modules in which optimal allocations of the processors to partitions to optimize cache usage depends on a location of the processors on the multi-chip modules.

17. A computer program product in a computer readable medium for assigning processors to partitions in a multi-processor data processing system, the computer program product comprising:
first instructions for generating optimal allocation sets for unallocated processors in the multi-processor data processing system for a cache level, wherein each set includes an allocation of unallocated processors to at least one partition;
second instructions for determining whether a set in the optimal allocation sets match requirements for a set of partitions selected for the data processing system;
third instructions, responsive to a match existing, for removing processors in the set from the unallocated processors, wherein cache usage by the processors is optimized for the cache level.

18. The computer program product of claim 17 further comprising:
fourth instructions for repeating the generating step, the determining step, and the removing step is performed for each cache level.

19. The computer program product of claim 18, wherein the method starts at a highest cache level and moves to successively lower cache levels until all cache levels have been processed.

20. The computer program product of claim 17 further comprising:
sub-instructions for removing a partition from the set of partitions in response to allocating a set to the partition.

21. The computer program product of claim 17, wherein the multi-processor data processing system is a symmetric multi-processor data processing system.

22. The computer program product of claim 17, wherein the multi-processor data processing system includes an L3 cache and an L2 cache.

23. The computer program product of claim 17, wherein the processors are located on multi-chip modules in which optimal allocations of the processors to partitions to optimize cache usage depends on a location of the processors on the multi-chip modules.
